(19) United States
(12) Patent Application Publication
(10) Pub. No.: US 2022/0251276 A1
(43) Pub. Date: Aug. 11, 2022

(54) POLYCARBONATE-MODIFIED ACRYLIC RESIN, COATING MATERIAL, AND MOLDED PLASTIC ARTICLE COATED WITH SAID COATING MATERIAL

(71) Applicant: DIC Corporation, Tokyo (JP)

(72) Inventors: Mio Himeno, Takaishi-shi (JP); Taku Murakawa, Takaishi-shi (JP)

(73) Assignee: DIC Corporation, Tokyo (JP)

(21) Appl. No.: 17/617,446

(22) PCT Filed: Jun. 11, 2020
(86) PCT No.: PCT/JP2020/022952

§ 371 Date: Dec. 8, 2021

(30) Foreign Application Priority Data
Jun. 19, 2019 (JP) 2019-113696

(51) Int. Cl. C08F 283/02; C09D 151/08

(52) U.S. Cl. CPC C08F 283/02; C09D 151/08

(57) ABSTRACT

Provided is a polycarbonate-modified acrylic resin that is a reaction product of a polycarbonate diol (A) obtained from 1,4-butanediol as an essential raw material and an unsaturated monomer mixture (B) comprising as essential components methyl methacrylate, an unsaturated monomer (b1) having a hydroxyl group, and an unsaturated monomer (b2) having a carboxyl group, in which a mass ratio of the unsaturated monomer (b2) in the unsaturated monomer mixture (B) is in a range of 2 to 10%. The polycarbonate-modified acrylic resin can form a coating film having high adhesion to a plastic base material, excellent water resistance adhesion, and fragrance resistance, so that it can be suitably used as a coating material for coating various articles.

### TECHNICAL FIELD

The present invention relates to a polycarbonate-modified acrylic resin, a coating material, and a molded plastic article coated with said coating material.

### BACKGROUND ART

Conventionally, a polycarbonate-modified acrylic resin obtained by reacting unsaturated monomers in the presence of a polyol has been proposed, and it is known that a cured coating film of the resin has excellent adhesion to a base material, mechanical properties, and the like (see for example PTL 1).

However, although the coating film obtained from the polycarbonate-modified acrylic resin is excellent in scratch resistance and the like, there has been a drawback that fragrance resistance required for plastic coating materials and the like is insufficient in recent years. Therefore, there has been a demand for a material that can impart fragrance resistance in addition to the conventional adhesion and the like.

### CITATION LIST

### Patent Literature

PTL 1: Japanese Patent No. 6,249,212

### SUMMARY OF INVENTION

### Technical Problem

A problem to be solved by the present invention is to provide a polycarbonate-modified acrylic resin that can form a coating film having high adhesion to a plastic base material, excellent water resistance adhesion, and fragrance resistance, a coating material, and a molded plastic article coated with said coating material.

### Solution to Problem

As a result of diligent research to solve the above problem, the present inventors have found that by using a polycarbonate-modified acrylic resin which is a reaction product of a specific polycarbonate diol and an unsaturated monomer mixture containing a specific unsaturated monomer as an essential component, it is possible to obtain a coating film having high adhesion to the plastic base material, excellent water resistance adhesion, and fragrance resistance, and completed the invention.

That is, the present invention relates to: a polycarbonate-modified acrylic resin that is a reaction product of a polycarbonate diol (A) obtained from 1,4-butanediol as an essential raw material and an unsaturated monomer mixture (B) containing as essential components methyl methacrylate, an unsaturated monomer (b1) having a hydroxyl group, and an unsaturated monomer (b2) having a carboxyl group, in which a ratio of the unsaturated monomer (b2) in the unsaturated monomer mixture (B) is in a range of 2 to 10 mass %, a coating material, and a molded plastic article coated with said coating material.

### Advantageous Effects of Invention

The polycarbonate-modified acrylic resin of the present invention can form a coating film having high adhesion to the plastic base material, excellent water resistance adhesion, and fragrance resistance, so that it is useful for the coating material and the coating material can be coated on various molded plastic articles. Therefore, the polycarbonate-modified acrylic resin of the present invention can be used for the coating material for coating various articles such as: housings for electronic devices such as mobile phones, smartphones, tablet terminals, personal computers, digital cameras, and game machines; housings for home appliances such as televisions, refrigerators, washing machines, and air conditioners; and interior materials of various vehicles such as automobiles and railway vehicles.

### DESCRIPTION OF EMBODIMENTS

A polycarbonate-modified acrylic resin of the present invention is a polycarbonate-modified acrylic resin that is a reaction product of a polycarbonate diol (A) obtained from 1,4-butanediol as an essential raw material and an unsaturated monomer mixture (B) containing as essential components methyl methacrylate, an unsaturated monomer (b1) having a hydroxyl group, and an unsaturated monomer (b2) having a carboxyl group, in which a ratio of the unsaturated monomer (b2) in the unsaturated monomer mixture (B) is in a range of 2 to 10 mass %.

First, the polycarbonate diol (A) will be described. The polycarbonate diol (A) is a polycarbonate diol obtained from 1,4-butanediol as a raw material, and is obtained, for example, by reacting 1,4-butanediol and other diol compounds with a carbonic acid ester or phosgene.

Examples of the other diol compounds include 1,3-propanediol, 1,2-propanediol, 2-methyl-1,3-propanediol, 2,2-dimethyl-1,3-propanediol, 2-butyl-2-ethyl1,3-propanediol, 1,2-butanediol, 1,3-butanediol, 1,5-pentanediol, 2,4-pentanediol, 2-methyl-1,3-pentanediol, 3-methyl-1,5-pentanediol, 1,6-hexanediol, 1,5-hexanediol, and 2-ethyl-1,3-hexanediol, but 1,3-propanediol, 2-methyl-1,3-propanediol, and 1,6-hexanediol are preferred because they are more excellent in fragrance resistance. Note that the diol compounds can be used alone or in combination of two or more.

The mass ratio of 1,4-butanediol to the other diol compounds is preferably in a range of 30/70 to 90/10, and more preferably in the range of 50/50 to 90/10, because adhesion to a plastic base material and the fragrance resistance are further improved.

The number average molecular weight of the polycarbonate diol (A) is preferably in a range of 300 to 10,000, and more preferably in the range of 300 to 4,000, because the fragrance resistance is more excellent.

Next, the unsaturated monomer mixture (B) will be described. The unsaturated monomer mixture (B) is the polycarbonate-modified acrylic resin that is the reaction product with the unsaturated monomer mixture (B) containing as the essential components methyl methacrylate, the unsaturated monomer (b1) having a hydroxyl group, and the unsaturated monomer (b2) having a carboxyl group, in which the ratio of the unsaturated monomer (b2) in the unsaturated monomer mixture (B) is in the range of 2 to 10 mass %.

Examples of the unsaturated monomer (b1) having a hydroxyl group include 2-hydroxyethyl(meth)acrylate, 3-hydroxypropyl(meth)acrylate, 4-hydroxy-n-butyl(meth)acrylate, 2-hydroxypropyl(meth)acrylate, 2-hydroxy-n-butyl(meth)acrylate, 3-hydroxy-n-butyl(meth)acrylate, 1,4-cyclohexanedimethanol mono(meth)acrylate, glycerin mono(meth)acrylate, polyoxyethylene mono(meth)acrylate, polyoxypropylene mono(meth)acrylate, polyoxybutylene mono(meth)acrylate, 2-hydroxy-3-phenoxypropyl(meth)acrylate, 2-(meth)acryloyloxyethyl-2-hydroxyethyl phthalate, and polycaprolactone-modified hydroxyethyl mono(meth)acrylate. Among them, 2-hydroxyethyl(meth)acrylate is preferred because a coating film to be obtained is more excellent in appearance, the water resistance adhesion, and the fragrance resistance. Note that these unsaturated monomers (b1) can be used alone or in combination of two or more.

Note that in the present invention, “(meth)acrylic acid” refers to one or both of methacrylic acid and acrylic acid, and “(meth)acrylate” refers to one or both of methacrylate and acrylate, and “(meth)acryloyl group” refers to one or both of a methacryloyl group and an acryloyl group.

Examples of the unsaturated monomer (b2) having a carboxyl group include: unsaturated monocarboxylic acids such as (meth)acrylic acid, crotonic acid, β-carboxyethyl(meth)acrylate, co-carboxy-polycaprolactone mono(meth)acrylate, 2-(meth)acryloyloxyethyl succinate, and 2-(meth)acryloyloxyethyl hexahydrophthalic acid; and unsaturated dicarboxylic acids such as maleic acid, fumaric acid, and itaconic acid, or half esters of these unsaturated dicarboxylic acids. Among them, (meth)acrylic acid is preferred because the coating film to be obtained is more excellent in the fragrance resistance. Note that these unsaturated monomers (b2) can be used alone or in combination of two or more.

The unsaturated monomer mixture (B) contains methyl methacrylate, the unsaturated monomer (b1) and the unsaturated monomer (b2) as the essential components, but preferably contains an unsaturated monomer (b3) having an alkyl group having 2 to 18 carbon atoms, because wettability of the coating film is further improved.

Examples of the unsaturated monomer (b3) include ethyl(meth)acrylate, n-propyl(meth)acrylate, isopropyl(meth)acrylate, n-butyl(meth)acrylate, isobutyl(meth)acrylate, tert-butyl(meth)acrylate, n-pentyl(meth)acrylate, n-hexyl(meth)acrylate, n-heptyl(meth)acrylate, n-octyl(meth)acrylate, 2-ethylhexyl(meth)acrylate, nonyl(meth)acrylate, decyl(meth)acrylate, dodecyl(meth)acrylate, tridecyl(meth)acrylate, cetyl(meth)acrylate, cyclohexyl(meth)acrylate, 4-tert-butylcyclohexyl(meth)acrylate, isobornyl(meth)acrylate, and dicyclopentanyl(meth)acrylate. In addition, these unsaturated monomers (b3) can be used alone or in combination of two or more.

As the unsaturated monomer mixture (B), a monomer (b4) other than the unsaturated monomer described above may be used. Examples of other monomers (b4) include methyl acrylate, stearyl(meth)acrylate, behenyl(meth)acrylate, benzyl(meth)acrylate; acrylamide, N,N-dimethyl(meth)acrylamide, (meth) acrylonitrile, 3-(meth) acryloyloxypropyltrimethoxysilane, N,N-dimethylaminoethyl(meth)acrylate, 2-(meth) acryloyloxyethyl acid phosphate, glycidyl(meth)acrylate, vinyl acetate, styrene, a-methyl styrene, p-methylstyrene, p-methoxystyrene, and diacrylate compounds such as ethylene glycol diacrylate. In addition, these unsaturated monomers can be used alone or in combination of two or more.

The unsaturated monomer mixture (B) has a ratio of the unsaturated monomer (b2) in the range of 2 to 10 mass %, but preferably has the ratio of the unsaturated monomer (b2) in the range of 2 to 5 mass o, because the coating film to be obtained is more excellent in the water resistance adhesion and the fragrance resistance.

The unsaturated monomer mixture (B) contains methyl(meth)acrylate and the unsaturated monomer (b1) as the essential components in addition to the unsaturated monomer (b2), but it is preferred that a ratio of methyl(meth)acrylate is in the range of 20 to 90 mass %, and a ratio of the unsaturated monomer (b1) is 1 to 50 mass o, and it is more preferred that the ratio of methyl(meth)acrylate is in the range of 40 to 80 mass %, and the ratio of the unsaturated monomer (b1) is in the range of 10 to 40 mass %, because the coating film to be obtained is more excellent in the fragrance resistance.

Further, the ratio of the unsaturated monomer (b3) is preferably in the range of 1 to 30 mass o, and more preferably in the range of 1 to 20 mass %, because the coating film to be obtained is more excellent in the water resistance adhesion and the fragrance resistance.

Further, the glass transition temperature (hereinafter abbreviated as “design Tg”) calculated by the FOX formula of the unsaturated monomer mixture (A) is preferably in a range of 60 to 110° C., because the fragrance resistance of the coating film to be obtained is further improved.

Note that in the present invention, the glass transition temperature calculated by the FOX formula is obtained by calculation according to

1/Tg=W1/Tg1+W2/Tg2 + the FOX formula:

(Tg: glass transition temperature to be obtained, W1: weight fraction of component 1, Tg1: glass transition temperature of homopolymer of component 1)

As values of glass transition temperatures of homopolymers of components, values described in Polymer Handbook (4th Edition) written by J. Brandrup, E. H. Immergut, E. A. Grulke (Wiley Interscience) were used.

As a method for obtaining the polycarbonate-modified acrylic resin of the present invention, a method of radically polymerizing the unsaturated monomer mixture (B) in the presence of the polycarbonate diol (A) and a solvent is preferred because it is simple.

The above-mentioned radical polymerization method is a method in which monomers as raw materials are dissolved in the solvent and a polymerization reaction is carried out in the presence of a polymerization initiator. Examples of the solvent that can be used in this case include: aromatic hydrocarbon compounds such as toluene and xylene; alicyclic hydrocarbon compounds such as cyclohexane, methyl cyclohexane, and ethyl cyclohexane; ketone compounds such as acetone, methyl ethyl ketone, methyl isobutyl ketone, and cyclohexanone; ester compounds such as ethyl acetate, n-butyl acetate, isobutyl acetate, and propylene glycol monomethyl ether acetate; alcohol compounds such as n-butanol, isopropyl alcohol, and cyclohexanol; glycol compounds such as ethylene glycol monobutyl ether and propylene glycol monomethyl ether; and aliphatic hydrocarbon compounds such as heptane, hexane, octane, and mineral turpentine.

Examples of the polymerization initiator include: organic peroxides such as ketone peroxide compounds such as cyclohexanone peroxide, 3,3,5-trimethylcyclohexanone peroxide, and methylcyclohexanone peroxide; peroxyketal compounds such as 1,1-bis(tert-butylperoxy)-3,3,5-trimethylcyclohexane, 1,1-bis(tert-butylperoxy) cyclohexane, n-butyl-4,4-bis(tert-butylperoxy) valerate, 2,2-bis(4,4-ditert-butylperoxycyclohexyl)propane, 2,2-bis(4,4-ditert-amylperoxycyclohexyl)propane, 2,2-bis(4,4-ditert-hexylperoxycyclohexyl)propane, 2,2-bis(4,4-ditert-octylperoxycyclohexyl)propane, and 2,2-bis(4,4-dicumylperoxycyclohexyl)propane; hydroperoxide compounds such as cumene hydroperoxide, and 2,5-dimethylhexane-2,5-dihydroperoxide; dialkyl peroxide compounds such as 1,3-bis(tert-butylperoxy-m-isopropyl)benzene, 2,5-dimethyl-2,5-di(tert-butylperoxy)hexane, diisopropylbenzene peroxide, tert-butylcumyl peroxide, and ditert-butyl peroxide; diacyl peroxide compounds such as decanoyl peroxide, lauroyl peroxide, benzoyl peroxide, and 2,4-dichlorobenzoyl peroxide; peroxycarbonate compounds such as bis(tert-butylcyclohexyl) peroxydicarbonate; and peroxyester compounds such as tert-butylperoxy-2-ethyl hexanoate, tert-butyl peroxybenzoate, and 2,5-dimethyl-2,5-di(benzoylperoxy)hexane; and azo compounds such as 2,2′-azobisisobutyronitrile, 2,2′-azobis(2-methyl)butyronitrile, and 1,1′-azobis(cyclohexane-1-carbonitrile).

Further, the mass ratio [(A)/(B)] of the polycarbonate diol (A) to the unsaturated monomer mixture (B) is preferably in the range of 2/98 to 60/40, more preferably in the range of 3/97 to 40/60, and still more preferably in the range of 4/96 to 15/85, because the water resistance adhesion and the fragrance resistance of the coating film to be obtained are further improved.

The hydroxyl value of the polycarbonate-modified acrylic resin of the present invention is preferably in a range of 20 to 150 mgKOH/g, and more preferably in the range of 60 to 150 mgKOH/g, because the fragrance resistance of the coating film to be obtained is further improved.

The weight average molecular weight (Mw) of the polycarbonate-modified acrylic resin of the present invention is preferably in the range of 2,000 to 50,000, and more preferably in the range of 4,000 to 30,000, because the water resistance adhesion and the fragrance resistance of the coating film to be obtained are further improved.

The average molecular weight of the present invention is a polystyrene equivalent value based on gel permeation chromatography (hereinafter abbreviated as “GPC”) measurement.

The coating material of the present invention contains the polycarbonate-modified acrylic resin of the present invention, but preferably contains a curing agent (C) because the physical properties of the coating film to be obtained are further improved.

Examples of the curing agent (C) include polyisocyanate compounds and amino resins, but the polyisocyanate compounds are preferred because the coating film to be obtained is excellent in the water resistance adhesion and the fragrance resistance. Further, these curing agents (C) can be used alone or in combination of two or more.

Examples of the polyisocyanate compounds include: aromatic diisocyanate compounds such as tolylene diisocyanate, diphenylmethane diisocyanate, m-xylylene diisocyanate, and m-phenylenebis(dimethylmethylene) diisocyanate; and aliphatic or alicyclic diisocyanate compounds such as hexamethylene diisocyanate, lysine diisocyanate, 1,3-bis(isocyanatomethyl)cyclohexane, 2-methyl-1,3-diisocyanatocyclohexane, 2-methyl-1,5-diisocyanatocyclohexane, 4,4′-dicyclohexylmethane diisocyanate, and isophorone diisocyanate.

Further, other compounds which can be used as the polyisocyanate compounds include: a prepolymer having an isocyanate group obtained by subjecting the above diisocyanate compound to an addition reaction with a polyhydric alcohol; a compound having an isocyanurate ring obtained by cyclizing and trimerizing the above diisocyanate compound; a polyisocyanate compound having a urea bond or a bullet bond obtained by reacting the above diisocyanate compound with water; a homopolymer of an acrylic monomer having an isocyanate group such as 2-isocyanatoethyl(meth)acrylate, 3-isopropenyl-a,a-dimethylbenzyl isocyanate, and (meth)acryloyl isocyanate; and a copolymer having an isocyanate group obtained by copolymerizing the acrylic monomer having an isocyanate group with another acrylic monomer, a vinyl ester compound, a vinyl ether compound, an aromatic vinyl monomer, and a monomer such as fluoroolefin.

The polyisocyanate compounds can be used alone or in combination of two or more.

When the curing agent (C) is the polyisocyanate compound, the blending amount of the polyisocyanate compound is preferably in a range of 0.5 to 2.0, and more preferably in the range of 0.7 to 1.3 in terms of the equivalent ratio (isocyanate group/hydroxyl group) of the isocyanate group in the polyisocyanate compound to the hydroxyl group in the polycarbonate-modified acrylic resin of the present invention because the coating film with high strength can be obtained.

Note that the above-mentioned urethanization reaction can also be carried out in the presence of a urethanization catalyst in order to accelerate the progress of the reaction. Examples of the urethanization catalyst include: amine compounds such as triethylamine; organic tin compounds such as dibutyltin dioctate, dibutyltin dilaurate, dioctyltin dilaurate, octyltin trilaurate, dioctyltin dineodecanate, dibutyltin diacetate, dioctyltin diacetate, and tin dioctylate; and organic metal compounds such as zinc octylate (zinc 2-ethylhexanoate).

The coating material of the present invention contains the polycarbonate-modified acrylic resin of the present invention and the curing agent (C), but as other formulations, additives such as a solvent, a defoamer, a viscosity modifier, a light stabilizer, a weather stabilizer, a heat stabilizer, a UV absorber, an antioxidant, a leveling agent, and a pigment dispersant can be used. Further, pigments such as titanium oxide, calcium carbonate, aluminum powder, copper powder, mica powder, iron oxide, carbon black, phthalocyanine blue, toluidine red, perylene, quinacridone, and benzidine yellow can also be used.

Since the coating material of the present invention has high adhesion to the plastic base material, it can be suitably used as the coating material for coating various molded plastic articles, but examples of the molded plastic article capable of being coated with the coating material of the present invention include: housings for electronic devices such as mobile phones, smartphones, tablet terminals, personal computers, digital cameras, and game machines; housings for home appliances such as televisions, refrigerators, washing machines, and air conditioners; and interior materials of various vehicles such as automobiles and railway vehicles.

Examples of methods for coating the coating material of the present invention include spray, applicator, bar coater, gravure coater, roll coater, comma coater, knife coater, air knife coater, curtain coater, kiss coater, shower coater, wheeler coater, spin coater, dipping, and screen printing. Further, an example of a method for forming the coating film after coating includes a method of drying in a range of room temperature to 120° C.

### EXAMPLES

Hereinafter, the present invention will be described in more detail with reference to specific examples. Note that the hydroxyl value of the polycarbonate-modified acrylic resin of the present invention was measured according to JIS test method K0070-1992. Further, the average molecular weight was measured under the following GPC measurement conditions.

### [GPC Measurement Conditions]

Measuring apparatus: High-speed GPC apparatus (“HLC-8220GPC” manufactured by Tosoh Corporation)
Column: The following columns manufactured by Tosoh Corporation were connected in series and used.

“TSKgel G5000” (7.8 mm I.D.×30 cm)×1 column

“TSKgel G4000” (7.8 mm I.D.×30 cm)×1 column

“TSKgel G3000” (7.8 mm I.D.×30 cm)×1 column

“TSKgel G2000” (7.8 mm I.D.×30 cm)×1 column
Detector: RI (Differential Refractometer)
Column temperature: 40° C.
Eluent: tetrahydrofuran (THF)
Flow rate: 1.0 mL/min
Injection volume: 100 μL (tetrahydrofuran solution with a sample concentration of 4 mg/mL)
Standard sample: A calibration curve was prepared using the following monodisperse polystyrene.

### (Monodisperse Polystyrene)

“TSKgel standard polystyrene A-500” manufactured by Tosoh Corporation

“TSKgel standard polystyrene A-1000” manufactured by Tosoh Corporation

“TSKgel standard polystyrene A-2500” manufactured by Tosoh Corporation

“TSKgel standard polystyrene A-5000” manufactured by Tosoh Corporation

“TSKgel standard polystyrene F-1” manufactured by Tosoh Corporation

“TSKgel standard polystyrene F-2” manufactured by Tosoh Corporation

“TSKgel standard polystyrene F-4” manufactured by Tosoh Corporation

“TSKgel standard polystyrene F-10” manufactured by Tosoh Corporation

“TSKgel standard polystyrene F-20” manufactured by Tosoh Corporation

“TSKgel standard polystyrene F-40” manufactured by Tosoh Corporation

“TSKgel standard polystyrene F-80” manufactured by Tosoh Corporation

“TSKgel standard polystyrene F-128” manufactured by Tosoh Corporation

“TSKgel standard polystyrene F-288” manufactured by Tosoh Corporation

“TSKgel standard polystyrene F-550” manufactured by Tosoh Corporation

### Example 1

### Synthesis of Polycarbonate-Modified Acrylic Resin (1)

A flask equipped with a cooling tube, a thermometer, a dropping funnel, and a stirrer was charged with 40 parts by mass of polycarbonate diol (“DURANOL G3452” produced by Asahi Kasei Chemicals Corporation, number average molecular weight 2000; hereinafter abbreviated as “polycarbonate diol (A-1)”) obtained from 1,4-butanediol as an essential raw material, 88.7 parts by mass of propylene glycol monomethyl ether acetate, and 354.8 parts by mass of n-butyl acetate, and the internal temperature was raised to 135° C. Subsequently, a mixture (acrylic part design Tg 80° C.) of 445.6 parts by mass of methyl methacrylate, 36 parts by mass of ethyl acrylate, 252.8 parts by mass of 2-hydroxyethyl acrylate, 25.6 parts by mass of methacrylic acid, 160 parts by mass of n-butyl acetate, and 32 parts by mass of tert-butyl peroxy-2-ethylhexanoate was added dropwise over 5 hours. After the reaction was continued at the same temperature for 17 hours after completion of the dropping, the mixture was diluted with propylene glycol monomethyl ether acetate so that the non-volatile content was 50 mass %, to obtain a solution of a polycarbonate-modified acrylic resin (1) having the mass ratio [(A)/(B)] of 5/95, an average molecular weight of 10,500, and a solid content hydroxyl value of 143 mgKOH/g.

### Example 2

### Synthesis of Polycarbonate-Modified Acrylic Resin (2)

A flask equipped with a cooling tube, a thermometer, a dropping funnel, and a stirrer was charged with 40 parts by mass of polycarbonate diol (“DURANOL G3450J” produced by Asahi Kasei Chemicals Corporation, number average molecular weight 800; hereinafter abbreviated as “polycarbonate diol (A-2)”) obtained from 1,4-butanediol as an essential raw material, and 443.5 parts by mass of n-butyl acetate, and the internal temperature was raised to 135° C. Subsequently, a mixture (acrylic part design Tg 90° C.) of 542.4 parts by mass of methyl methacrylate, 20 parts by mass of ethyl acrylate, 164 parts by mass of 2-hydroxyethyl acrylate, 33.6 parts by mass of methacrylic acid, 160 parts by mass of n-butyl acetate, and 28 parts by mass of tert-butyl peroxy-2-ethylhexanoate was added dropwise over 5 hours. After the reaction was continued at the same temperature for 17 hours after completion of the dropping, the mixture was diluted with propylene glycol monomethyl ether acetate so that the non-volatile content was 50 mass %, to obtain a solution of a polycarbonate-modified acrylic resin (2) having the mass ratio [(A)/(B)] of 5/95, an average molecular weight of 12,100, and a solid content hydroxyl value of 95 mgKOH/g.

### Example 3

### Synthesis of Polycarbonate-Modified Acrylic Resin (3)

A flask equipped with a cooling tube, a thermometer, a dropping funnel, and a stirrer was charged with 120 parts by mass of polycarbonate diol (A-2) and 420.2 parts by mass of n-butyl acetate, and the internal temperature was raised to 130° C. Subsequently, a mixture (acrylic part design Tg 86° C.) of 456 parts by mass of methyl methacrylate, 16 parts by mass of ethyl acrylate, 192 parts by mass of 2-hydroxyethyl acrylate, 16 parts by mass of methacrylic acid, 160 parts by mass of n-butyl acetate, and 26.4 parts by mass of tert-butyl peroxy-2-ethylhexanoate was added dropwise over 5 hours. After the reaction was continued at the same temperature for 17 hours after completion of the dropping, the mixture was diluted with propylene glycol monomethyl ether acetate so that the non-volatile content was 50 mass %, to obtain a solution of a polycarbonate-modified acrylic resin (3) having the mass ratio [(A)/(B)] of 15/85, an average molecular weight of 14,800, and a solid content hydroxyl value of 125 mgKOH/g.

### Example 4

### Synthesis of Polycarbonate-Modified Acrylic Resin (4)

A flask equipped with a cooling tube, a thermometer, a dropping funnel, and a stirrer was charged with 120 parts by mass of polycarbonate diol (A-1), 83.2 parts by mass of propylene glycol monomethyl ether acetate, and 332.6 parts by mass of n-butyl acetate, and the internal temperature was raised to 130° C. Subsequently, a mixture (acrylic part design Tg 85° C.) of 396 parts by mass of methyl methacrylate, 8 parts by mass of ethyl acrylate, 240 parts by mass of 2-hydroxyethyl acrylate, 36 parts by mass of methacrylic acid, 160 parts by mass of n-butyl acetate, and 32 parts by mass of tert-butyl peroxy-2-ethylhexanoate was added dropwise over 5 hours. After the reaction was continued at the same temperature for 17 hours after completion of the dropping, the mixture was diluted with propylene glycol monomethyl ether acetate so that the non-volatile content was 50 mass %, to obtain a solution of a polycarbonate-modified acrylic resin (4) having the mass ratio [(A)/(B)] of 15/85, an average molecular weight of 11,900, and a solid content hydroxyl value of 150 mgKOH/g.

### Example 5

### Synthesis of Polycarbonate-Modified Acrylic Resin (5)

A flask equipped with a cooling tube, a thermometer, a dropping funnel, and a stirrer was charged with 240 parts by mass of polycarbonate diol (A-1), 90 parts by mass of propylene glycol monomethyl ether acetate, and 313.2 parts by mass of n-butyl acetate, and the internal temperature was raised to 125° C. Subsequently, a mixture (acrylic part design Tg 88° C.) of 361.6 parts by mass of methyl methacrylate, 8 parts by mass of ethyl acrylate, 160.8 parts by mass of 2-hydroxyethyl acrylate, 29.6 parts by mass of methacrylic acid, 160 parts by mass of n-butyl acetate, and 30.4 parts by mass of tert-butyl peroxy-2-ethylhexanoate was added dropwise over 5 hours. After the reaction was continued at the same temperature for 17 hours after completion of the dropping, the mixture was diluted with propylene glycol monomethyl ether acetate so that the non-volatile content was 50 mass %, to obtain a solution of a polycarbonate-modified acrylic resin (5) having the mass ratio [(A)/(B)] of 30/70, an average molecular weight of 14,900, and a solid content hydroxyl value of 128 mgKOH/g.

### Example 6

### Synthesis of Polycarbonate-Modified Acrylic Resin (6)

A flask equipped with a cooling tube, a thermometer, a dropping funnel, and a stirrer was charged with 40 parts by mass of polycarbonate diol (“DURANOL G4671” produced by Asahi Kasei Chemicals Corporation, number average molecular weight 1000; hereinafter abbreviated as “polycarbonate diol (A-3)”) obtained from 1,4-butanediol as an essential raw material and 443.5 parts by mass of n-butyl acetate, and the internal temperature was raised to 130° C. Subsequently, a mixture (acrylic part design Tg 73° C.) of 470.4 parts by mass of methyl methacrylate, 89.6 parts by mass of ethyl acrylate, 174.4 parts by mass of 2-hydroxyethyl acrylate, 25.6 parts by mass of methacrylic acid, 160 parts by mass of n-butyl acetate, and 32 parts by mass of tert-butyl peroxy-2-ethylhexanoate was added dropwise over 5 hours. After the reaction was continued at the same temperature for 17 hours after completion of the dropping, the mixture was diluted with n-butyl acetate so that the non-volatile content was 50 mass %, to obtain a solution of a polycarbonate-modified acrylic resin (6) having the mass ratio [(A)/(B)] of 5/95, an average molecular weight of 11,000, and a solid content hydroxyl value of 100 mgKOH/g.

### Example 7

### Synthesis of Polycarbonate-Modified Acrylic Resin (7)

A flask equipped with a cooling tube, a thermometer, a dropping funnel, and a stirrer was charged with 80 parts by mass of polycarbonate diol (A-3) and 443.5 parts by mass of n-butyl acetate, and the internal temperature was raised to 125° C. Subsequently, a mixture (acrylic part design Tg 89° C.) of 502.4 parts by mass of methyl methacrylate, 20 parts by mass of ethyl acrylate, 164 parts by mass of 2-hydroxyethyl acrylate, 33.6 parts by mass of methacrylic acid, 160 parts by mass of n-butyl acetate, and 22.8 parts by mass of tert-butyl peroxy-2-ethylhexanoate was added dropwise over 5 hours. After the reaction was continued at the same temperature for 17 hours after completion of the dropping, the mixture was diluted with n-butyl acetate so that the non-volatile content was 50 mass %, to obtain a solution of a polycarbonate-modified acrylic resin (7) having the mass ratio [(A)/(B)] of 10/90, an average molecular weight of 16,000, and a solid content hydroxyl value of 100 mgKOH/g.

### Comparative Example 1

### Synthesis of Comparative Resin (R1)

A flask equipped with a cooling tube, a thermometer, a dropping funnel, and a stirrer was charged with 443.5 parts by mass of n-butyl acetate, and the internal temperature was raised to 135° C. Subsequently, a mixture (acrylic part design Tg 83° C.) of 525.6 parts by mass of methyl methacrylate, 36 parts by mass of ethyl acrylate, 212. parts by mass of 2-hydroxyethyl acrylate, 26.4 parts by mass of methacrylic acid, 160 parts by mass of n-butyl acetate, and 32 parts by mass of tert-butyl peroxy-2-ethylhexanoate was added dropwise over 5 hours. After the reaction was continued at the same temperature for 17 hours after completion of the dropping, the mixture was diluted with propylene glycol monomethyl ether acetate so that the non-volatile content was 50 mass o, to obtain a solution of a comparative resin (R1) having the mass ratio [(A)/(B)] of 0/100, an average molecular weight of 9,400, and a solid content hydroxyl value of 114 mgKOH/g.

### Comparative Example 2

### Synthesis of Comparative Resin (R2)

A flask equipped with a cooling tube, a thermometer, a dropping funnel, and a stirrer was charged with 40 parts by mass of polycarbonate diol (A-1), 83.3 parts by mass of propylene glycol monomethyl ether acetate, and 331.9 parts by mass of n-butyl acetate, and the internal temperature was raised to 130° C. Subsequently, a mixture (acrylic part design Tg 85° C.) of 549.6 parts by mass of methyl methacrylate, 34.4 parts by mass of ethyl acrylate, 166.4 parts by mass of 2-hydroxyethyl acrylate, 9.6 parts by mass of methacrylic acid, 160 parts by mass of n-butyl acetate, and 32 parts by mass of tert-butyl peroxy-2-ethylhexanoate was added dropwise over 5 hours. After the reaction was continued at the same temperature for 17 hours after completion of the dropping, the mixture was diluted with propylene glycol monomethyl ether acetate so that the non-volatile content was 50 mass o, to obtain a solution of a comparative resin (R2) having the mass ratio [(A)/(B)] of 5/95, an average molecular weight of 10,000, and a solid content hydroxyl value of 97 mgKOH/g.

### Comparative Example 3

### Synthesis of Comparative Resin (R3)

A flask equipped with a cooling tube, a thermometer, a dropping funnel, and a stirrer was charged with 257 parts by mass of polycarbonate diol (A-1) and 474 parts by mass of propylene glycol monomethyl ether acetate, and the internal temperature was raised to 135° C. Subsequently, a mixture (acrylic part design Tg 93° C.) of 510 parts by mass of methyl methacrylate, 60 parts by mass of cyclohexyl methacrylate, 26 parts by mass of 2-hydroxyethyl acrylate, 4 parts by mass of methacrylic acid, 120 parts by mass of propylene glycol monomethyl ether acetate, and 12 parts by mass of tert-butyl peroxybenzoate was added dropwise over 5 hours. After the reaction was continued at the same temperature for 17 hours after completion of the dropping, the mixture was diluted with propylene glycol monomethyl ether acetate so that the non-volatile content was 50 mass %, to obtain a solution of a comparative resin (R4) having the mass ratio [(A)/(B)] of 30/70, an average molecular weight of 11,000, and a solid content hydroxyl value of 57 mgKOH/g.

### Comparative Example 4

### Synthesis of Comparative Resin (R4)

A flask equipped with a cooling tube, a thermometer, a dropping funnel, and a stirrer was charged with 40 parts by mass of polycarbonate diol (A-3) and 498.4 parts by mass of n-butyl acetate, and the internal temperature was raised to 125° C. Subsequently, a mixture (acrylic part design Tg 95° C.) of 502.4 parts by mass of methyl methacrylate, 14.4 parts by mass of ethyl acrylate, 148 parts by mass of 2-hydroxyethyl acrylate, 99.2 parts by mass of methacrylic acid, 160 parts by mass of n-butyl acetate, and 32 parts by mass of tert-butyl peroxy-2-ethylhexanoate was added dropwise over 5 hours. After the reaction was continued at the same temperature for 17 hours after completion of the dropping, the mixture was diluted with n-butyl acetate so that the non-volatile content was 50 mass %, to obtain a solution of a comparative resin (R4) having the mass ratio [(A)/(B)] of 5/95, an average molecular weight of 9,900, and a solid content hydroxyl value of 85 mgKOH/g.

The compositions of the polycarbonate-modified acrylic resins (1) to (7) obtained above are shown in Table 1.

TABLE 1

| | | | | Example 1 | Example 2 | Example 3 | Example 4 | Example 5 | Example 6 | Example 7 |
|---|---|---|---|---|---|---|---|---|---|---|
| Polycarbonate-modified acrylic resin | | | | (1) | (2) | (3) | (4) | (5) | (6) | (7) |
| Composition | Polycarbonate diol | | (A-1) | 5 | | | 15 | 30 | | |
| (parts by | | | (A-2) | | 5 | 15 | | | | |
| mass) | | | (A-3) | | | | | | 5 | 10 |
| | Unsaturated | MMA | | 55.7 | 67.8 | 57.0 | 49.5 | 45.2 | 58.8 | 62.8 |
| | monomer | Unsaturated | HEMA | 31.6 | 20.5 | 24.0 | 30.0 | 20.1 | 21.8 | 20.5 |
| | mixture | monomer (b1) | | | | | | | | |
| | | Unsaturated | MAA | 3.2 | 4.2 | 2.0 | 4.5 | 3.7 | 3.2 | 4.2 |
| | | monomer (b2) | | | | | | | | |
| | | Unsaturated | EA | 4.5 | 2.5 | 2.0 | 1.0 | 1.0 | 11.2 | 2.5 |
| | | monomer (b3) | | | | | | | | |

| | | | | | | | |
|---|---|---|---|---|---|---|---|
| Mass ratio (%) of | 3.4 | 4.4 | 2.4 | 5.3 | 5.3 | 3.4 | 4.7 |
| unsaturated | | | | | | | |
| monomer (b2) | | | | | | | |

| | | | | | | | |
|---|---|---|---|---|---|---|---|
| Polycarbonate diol/Unsaturated | 5/95 | 5/95 | 15/85 | 15/85 | 30/70 | 5/95 | 10/90 |
| monomer mixture (mass ratio) | | | | | | | |
| Weight average molecular weight | 10,500 | 12,100 | 14,800 | 11,900 | 14,900 | 11,000 | 16,000 |

The abbreviations in Table 1 and Table 2 are as follows.

MMA: Methyl methacrylate

HEMA: 2-Hydroxyethyl methacrylate

HEA: 2-hydroxyethyl acrylate

MAA: Methacrylic acid

EA: Ethyl acrylate

CHMA: Cyclohexyl methacrylate

The compositions of the comparative resins (R1) to (R4) obtained above are shown in Table 2.

TABLE 2

| | | | | Comparative | Comparative | Comparative | Comparative |
|---|---|---|---|---|---|---|---|
| | | | | Example 1 | Example 2 | Example 3 | Example 4 |
| Comparative resin | | | | (R1) | (R2) | (R3) | (R4) |
| Composition | Polycarbonate diol | | (A-1) | | 5 | 30 | |
| (parts by | | | (A-3) | | | | 5 |
| mass) | Unsaturated | MMA | | 65.7 | 68.7 | 59.5 | 62.3 |
| | monomer | Unsaturated | HEMA | 26.5 | 20.8 | | 18.5 |
| | mixture | monomer (b1) | HEA | | | 3.1 | |
| | | Unsaturated | MAA | 3.3 | 1.2 | 0.4 | 12.4 |
| | | monomer (b2) | | | | | |
| | | Unsaturated | EA | 4.5 | 4.3 | | 1.8 |
| | | monomer (b3) | CHMA | | | 7.0 | |

| | | | | |
|---|---|---|---|---|
| Mass ratio (%) of | 3.3 | 1.3 | 0.6 | 13.1 |
| unsaturated | | | | |
| monomer (b2) | | | | |

| | | | | |
|---|---|---|---|---|
| Polycarbonate diol/Unsaturated | 0/100 | 5/95 | 30/70 | 5/95 |
| monomer mixture (mass ratio) | | | | |
| Weight average molecular weight | 9,400 | 10,000 | 11,100 | 9,900 |

### Example 8

### Preparation and Evaluation of Coating Material (1)

### [Preparation of Coating Material]

A solution (non-volatile content 60 mass %) of the polycarbonate-modified acrylic resin (1) obtained in Example 1 above, and the curing agent (“Sumijule N-3300” produced by Sumika Cobestro Urethane Co., Ltd., polyisocyanate compound) were uniformly mixed. Note that the blending ratio of the polycarbonate-modified acrylic resin (1) to the curing agent was such that the equivalent of hydroxyl groups in the polycarbonate-modified acrylic resin (1) to the equivalent of isocyanate groups in the curing agent was 1:1.

Subsequently, the mixture was diluted with a mixed solvent (butyl acetate/diacetone alcohol/isobutyl acetate/ethyl acetate=30/30/30/10 (mass ratio)) so that the viscosity is 9 to 10 seconds (23° C.) with “Viscosity Cup NK-2” manufactured by ANEST IWATA Corporation, to prepare a coating material (1).

### [Preparation of Cured Coating Film X for Evaluation]

The coating material (1) obtained above was spray-coated on an acrylonitrile-butadiene-styrene copolymer (ABS) base material (50 mm×70 mmxl mm) so that the film thickness after drying is 15 to 25 μm, and heat-dried at 80° C. for 30 minutes with a dryer, and then dried at 25 ° C. for 7 days, to prepare a cured coating film X for evaluation.

### [Preparation of Cured Coating Film Y for Evaluation]

The coating material (1) obtained above was spray-coated on a polycarbonate (PC) base material (50 mm×70 mm×1 mm) so that the film thickness after drying is 20 to 30 μm, and heat-dried at 80° C. for 30 minutes with a dryer, and then dried at 25 ° C. for 7 days, to prepare a cured coating film Y for evaluation.

### [Evaluation of Adhesion]

1 mm wide cutouts were made on the cured coating film for evaluation obtained above with a cutter, to make 100 grids. Subsequently, a cellophane tape was attached to the film so as to cover all the grids, operations of quickly peeling the tape was performed four times, and the adhesion was evaluated from the number of grids remaining attached according to the following criteria.

A: 100 pieces

B: 70 to 99 pieces

C: 69 pieces or less

### [Evaluation of Water Resistance Adhesion]

After immersing the cured coating film for evaluation obtained above in water at 40° C. for 240 hours, the same operation as the above adhesion evaluation was performed, and the water resistance adhesion was evaluated according to the following criteria.

A: 100 pieces

B: 70 to 99 pieces

C: 69 pieces or less

### [Evaluation of Fragrance Resistance]

On the cured coating film X for evaluation obtained above, a fragrance (Little Tree Air Freshener “Royal Pine”) cut into 15 mm×15 mm was placed, and after the film was dried at 74° C. for 4 hours while applying a load with a weight of 500 g, the fragrance was removed by hand, the appearance was visually observed, and the fragrance resistance was evaluated according to the following criteria.
5: No trace
4: Slight traces
3: Traces
2: Fragrance can be removed, but base material is exposed
1: Fragrance cannot be removed from base material in an adhesive state

### Examples 9 to 14

### Preparation and Evaluation of Coating Materials (2) to (7)

Coating materials were prepared by operating in the same manner as in Example 6 except that the polycarbonate-modified acrylic resin (1) of Example 6 was changed to the polycarbonate-modified acrylic resins (2) to (7), and then the cured coating films for evaluation were prepared and evaluated.

### Comparative Examples 5 to 8

### Preparation and Evaluation of Coating Materials (R1) to (R4)

Coating materials were prepared by operating in the same manner as in Example 8 except that the polycarbonate-modified acrylic resin (1) of Example 8 was changed to comparative resins (R1) to (R4), and then the cured coating films for evaluation were prepared and evaluated.

Table 3 shows evaluation results of the coating materials (1) to (7) obtained above.

TABLE 3

| | | Example 8 | Example 9 | Example 10 | Example 11 | Example 12 | Example 13 | Example 14 |
|---|---|---|---|---|---|---|---|---|
| Coating material | | (1) | (2) | (3) | (4) | (5) | (6) | (7) |
| Evaluation | Initial adhesion | A | A | A | A | A | A | A |
| | (ABS base material) | | | | | | | |
| | Water resistance adhesion | A | A | A | A | A | A | A |
| | (ABS base material) | | | | | | | |
| | Initial adhesion | A | A | A | A | A | A | A |
| | (PC base material) | | | | | | | |
| | Water resistance adhesion | A | A | A | A | A | A | A |
| | (PC base material) | | | | | | | |
| | Fragrance resistance | 5 | 5 | 4 | 5 | 4 | 5 | 5 |

Table 4 shows evaluation results of the coating materials (R1) to (R4) obtained above.

TABLE 4

| | | Comparative | Comparative | Comparative | Comparative |
|---|---|---|---|---|---|
| | | Example 5 | Example 6 | Example 7 | Example 8 |
| Coating material | | (R1) | (R2) | (R3) | (R4) |
| Evaluation | Initial adhesion | A | A | A | A |
| | (ABS base material) | | | | |
| | Water resistance adhesion | A | B | A | C |
| | (ABS base material) | | | | |
| | Initial adhesion | C | A | A | A |
| | (PC base material) | | | | |
| | Water resistance adhesion | C | C | A | C |
| | (PC base material) | | | | |
| | Fragrance resistance | 5 | 5 | 2 | 5 |

It was found that the cured coating films obtained from Examples 1 to 7 of the polycarbonate-modified acrylic resin of the present invention were excellent in adhesion, water resistance adhesion, and fragrance resistance (Examples 8 to 14).

On the other hand, Comparative Example 1 is an example of an acrylic resin not modified with polycarbonate, and it was found that the obtained coating film was inferior in base material adhesion (Comparative Example 5).

Comparative Examples 2 and 3 are examples in which the mass ratio of the unsaturated monomer (b2) having a carboxyl group in the unsaturated monomer mixture is smaller than 2 mass % that is the lower limit of the present invention, and it was found that the obtained cured coating films were inferior in fragrance resistance (Comparative Examples 6 and 7).

Comparative Example 4 is an example in which the mass ratio of the unsaturated monomer having a carboxyl group in the unsaturated monomer mixture is larger than 10 mass % that is the upper limit of the present invention, and it was found that the obtained cured coating film was inferior in water resistance adhesion (Comparative Example 8).

1. A polycarbonate-modified acrylic resin that is a reaction product of a polycarbonate diol (A) obtained from 1,4-butanediol as an essential raw material and an unsaturated monomer mixture (B) comprising as essential components methyl methacrylate, an unsaturated monomer (b1) having a hydroxyl group, and an unsaturated monomer (b2) having a carboxyl group, wherein a ratio of the unsaturated monomer (b2) in the unsaturated monomer mixture (B) is in a range of 2 to 10 mass %.

2. The polycarbonate-modified acrylic resin according to claim 1, wherein the unsaturated monomer mixture (B) comprises an unsaturated monomer (b3) having an alkyl group having 2 to 18 carbon atoms.

3. The polycarbonate-modified acrylic resin according to claim 1, wherein a mass ratio [(A)/(B)] of the polycarbonate diol (A) to the unsaturated monomer mixture (B) is in a range of 2/98 to 60/40.

4. The polycarbonate-modified acrylic resin according to claim 1, wherein a ratio of methyl methacrylate in the unsaturated monomer mixture (B) is in a range of 20 to 90 mass %, a ratio of the unsaturated monomer (b1) is in a range of 1 to 50 mass %, and a ratio of the unsaturated monomer (b3) is in a range of 1 to 30 mass %.

5. A coating material comprising the polycarbonate-modified acrylic resin according to claim 1 and a curing agent (C).

6. A molded plastic article coated with the coating material according to claim 4.

7. The polycarbonate-modified acrylic resin according to claim 2, wherein a ratio of methyl methacrylate in the unsaturated monomer mixture (B) is in a range of 20 to 90 mass %, a ratio of the unsaturated monomer (b1) is in a range of 1 to 50 mass %, and a ratio of the unsaturated monomer (b3) is in a range of 1 to 30 mass %.

8. A coating material comprising the polycarbonate-modified acrylic resin according to claim 2 and a curing agent (C).

9. A coating material comprising the polycarbonate-modified acrylic resin according to claim 3 and a curing agent (C).

10. A molded plastic article coated with the coating material according to claim

7.
